(19) United States
(12) Patent Application Publication
(10) Pub. No.: US 2007/0103592 A1
(43) Pub. Date: May 10, 2007

(54) [METHOD OF SYNCHRONOUSLY RECEIVING DIGITAL AND ANALOG TELEVISION SIGNALS]

(75) Inventor: Yu-Chiang Shih, TAIPEI (TW)

Correspondence Address: ANIMATION TECHNOLOGIES INC., P.O. BOX 108-00403, TAIPEI, TW

(73) Assignee: ANIMATION TECHNOLOGIES INC., Hsintien City, Taipei Hsien (TW)

(21) Appl. No.: 11/163,129

(22) Filed: Oct. 6, 2005

(51) Int. Cl. H04N 3/27

(52) U.S. Cl. 348/554

(57) ABSTRACT

The present invention describes a method of synchronously receiving digital and analog television signals that installs an application software, a direct show, a driver and a tuner in a host end, and the digital television signals and analog television signals transmitted by the application software are sent to the driver through the direct show or directly to the driver, such that an analog television tuner and a digital television tuner installed in the tuner can simultaneously receive the digital and analog television signals for users to simultaneously or separately saving and playing the signals, so as to increase the types of viewed and saved the television signals and allow users to simultaneously process different types of the television signals.

### BACKGROUND OF THE INVENTION

1. Field of the Invention

The present invention relates to a method of synchronously receiving digital and analog television signals, and more particularly to a method of synchronously receiving digital and analog television signals and simultaneously or separately playing or storing the signals.

2. Description of Related Art

In recent years, digital technology is well developed and integrated circuit is extensively used, and thus digital signal processing has become very popular. As the multimedia industry develops, the electronic technology drastically advances and the personal computer becomes popular, our society is filled with information. The growth of digital televisions is fast and the construction of digital transmission stations built by related manufacturers is completed, and thus the coverage of digital signals becomes broader and broader. Related industries develop as the user population increases. Unlike traditional television signals, the digital television provides very high-resolution performance as well as diversified applications, so that users can enjoy many additional functions.

However, the present digital and analogy televisions are in a coexisting stage, and both digital and analog televisions provide different entertaining effects. However, users can only choose to receive either one of the analog television signals and the digital television signals for the playback on a computer through a video device (such as a television card or a television box). The traditional way does not allow users to choose both of the analog and digital television signals since most of the present signal transmissions use the Direct Show specified by Microsoft as the communication interface, and the Direct Show only provides one channel for transmitting television signals. Therefore, when the digital television signals are transmitted through the channel, the analog television signals cannot be transmitted. On the other hand, when the analog television signals are transmitted through the channel, the digital television signals cannot be transmitted. So, the users can only save or play one type of the television signals, but cannot simultaneously play or save both the digital and analog television signals. As a result, the adaptability to the types chosen by users is limited.

### SUMMARY OF THE INVENTION

The present invention has been accomplished under the circumstances in vies. It is therefore the main objective of the present invention to use a plurality of standard open interfaces and a specific interface installed in a driver to separately receive digital television signals and analog television signals and send these signals to a tuner, such that the tuner can simultaneously receive the digital television signals and the analog television signals for users to simultaneously or separately saving and playing the signals.

### BRIEF DESCRIPTION OF THE DRAWINGS

FIG. 1 is a schematic block diagram of the present invention.

FIG. 2 is a block diagram of using the present invention.

### DETAILED DESCRIPTION OF THE PREFERRED EMBODIMENTS

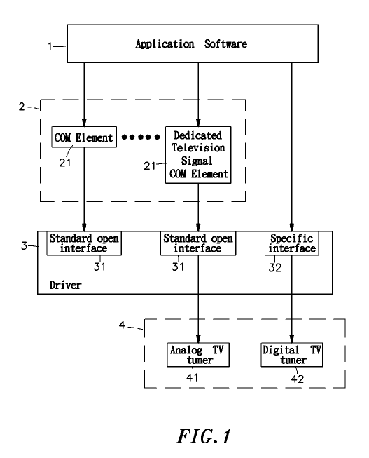

Referring to FIG. 1, a method of synchronously receiving digital and analog television signals of the present invention is installing application software 1, a direct show 2, a driver 3 and a tuner 4 in a host end; wherein the application software 1 can simultaneously receive digital and analog television signals.

The direct show 2 is established by Microsoft, which is standard software architecture between the application software 1 and the driver 3. The direct show 2 is comprised of a plurality of COM elements 21, and one of the COM elements 21 is a dedicated television signal.

The driver 3 installs a plurality of standard open interfaces 31 and a specific interface 32 therein.

The tuner 4 installs an analog television tuner 41 and a digital television tuner 42, and the analog television tuner 41 and digital television tuner 42 can receive digital or analog signals transmitted from the driver 3.

If the present invention is in use, one of the digital television signal and the analog television signal received by the application software 1 will be sent to the standard open interface 31 through the COM element 21 of the dedicated television signal in the direct show 2 and then transmitted from the driver 3 to the analog television tuner 41 or the digital television tuner 42, and the other type of television signals will be sent directly to the specific interface 32 of the driver 3 and then from the driver 3 to the analog television tuner 41 or the digital television tuner 42 corresponding to the television signal, so that the analog television tuner 41 and the analog television tuner 42 of the tuner 4 can simultaneously receive the analog and digital television signals.

Further, when the television signal received by the standard open interface 31 is the analog television signal, the specific interface 32 will receive the digital television signal. On the other hand, when the television signal received by the standard open interface 31 is the digital television signal, the specific interface 32 will receive the analog television signal.

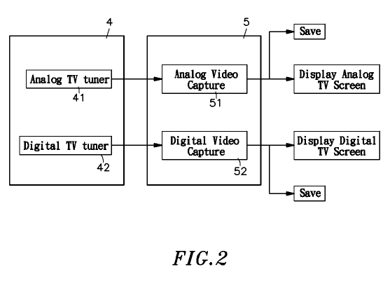

Referring to FIGS. 1 and 2, the analog and digital television signals received by the analog television tuner 41 and the digital television tuner 42 are captured respectively by an analog video capture 51 and a digital video capture 52 of a capture device 5, so as to simultaneously or separately display an analog television screen and a digital television screen. The analog television signal and the digital television signal captured by the analog video capture 51 and the digital video capture 52 can be saved simultaneously or separately.

Further, the host end could be a notebook computer or a desktop computer.

The method of synchronously receiving digital and analog television signals in accordance with the present invention can overcome the shortcomings of the prior art, since the invention uses the specific interface 32 installed in the driver 3 that allows the digital television signal and analog television signal received by the application software 1 to be simultaneously transmitted to the standard open interface 31 of the driver 3 through the direct show 2 and directly sent to the specific interface 32 of the driver 3. Therefore, the analog television tuner 41 and the digital television tuner 42 can simultaneously receive the digital and analog television signals for users to simultaneously or separately save and play the signals.

A method of synchronously receiving digital and analog signals has been constructed with the features of FIG. 1˜2. The method of synchronously receiving digital and analog signals functions smoothly to provide all of the features discussed earlier.

Although a particular embodiment of the invention has been described in detail for purposes of illustration, various modifications and enhancements may be made without departing from the spirit and scope of the invention.

What is claimed is:

1. A method of synchronously receiving digital and analog television signals, comprising application software, a direct show, a driver, and a tuner in a host end, wherein:
said application software is capable of simultaneously receiving digital and analog television signals;
said direct show installs a plurality of COM elements for receiving said analog television signals from said application software; and
said driver includes a plurality of standard open interfaces for receiving said analog television signals transmitted from said COM elements and a specific interface for receiving said digital television signals transmitted from said application software.

2. The method of synchronously receiving digital and analog television signals as claimed in claim 1, wherein said host end further comprises a tuner, and said tuner includes an analog television tuner and a digital television tuner for respectively receiving said analog television signals and said digital television signals transmitted from said driver.

3. The method of synchronously receiving digital and analog television signals as claimed in claim 1, wherein said host end further installs a capture device, and said capture device includes an analog video capture and a digital video capture for respectively capturing said analog television signals and said digital television signals received by said tuner.

4. The method of synchronously receiving digital and analog television signals as claimed in claim 1, wherein said host end is a notebook computer.

5. The method of synchronously receiving digital and analog television signals as claimed in claim 1, wherein said host end is a desktop computer.

6. A method of synchronously receiving digital and analog television signals, comprising application software, a direct show, a driver, and a tuner in a host end, wherein:
said application software is capable of simultaneously receiving digital and analog television signals;
said direct show installs a plurality of COM elements for receiving said digital television signals from said application software; and
said driver includes a plurality of standard open interfaces for receiving said digital television signals transmitted from said COM elements and a specific interface for receiving said analog television signals transmitted from said application software.

7. The method of synchronously receiving digital and analog television signals as claimed in claim 6, wherein said host end further comprises a tuner, and said tuner includes an analog television tuner and a digital television tuner for respectively receiving said analog television signals and said digital television signals transmitted from said driver.

8. The method of synchronously receiving digital and analog television signals as claimed in claim 6, wherein said host end further installs a capture device, and said capture device includes an analog video capture and a digital video capture for respectively capturing said analog television signals and said digital television signals received by said tuner.

9. The method of synchronously receiving digital and analog television signals as claimed in claim 6, wherein said host end is a notebook computer.

10. The method of synchronously receiving digital and analog television signals as claimed in claim 6, wherein said host end is a desktop computer.
